(19) United States
(12) Patent Application Publication
(10) Pub. No.: US 2025/0326068 A1
(43) Pub. Date: Oct. 23, 2025

(54) QUALITY TEST METHOD AND QUALITY TEST SYSTEM

(71) Applicant: SK On Co., Ltd., Seoul (KR)

(72) Inventors: Won Je OH, Daejeon (KR); Jae Gyu BYUN, Daejeon (KR); Gi Jeong SEO, Daejeon (KR)

(21) Appl. No.: 19/181,333

(22) Filed: Apr. 17, 2025

(30) Foreign Application Priority Data
Apr. 18, 2024 (KR) 10-2024-0051933

(51) Int. Cl. B23K 31/12; B23K 101/36; G06T 7/00; H01M 50/536

(52) U.S. Cl. CPC B23K 31/125; G06T 7/0006; H01M 50/536; B23K 2101/36

(57) ABSTRACT

The present disclosure relates to a test quality method and a test quality system. The quality test method of a battery cell including a can having an open surface; a cap welded to the can and covering the open surface; and a welding area formed by welding according to embodiments of the present disclosure includes capturing an image of the welding area with an imaging device, calculating a plurality of first points arranged along a first boundary line and a plurality of second points corresponding to the plurality of first points and arranged along a second boundary line, the first and second boundary lines separating the welding area from a non-welding area in the image, and determining whether the welding area is defective based on a number of the plurality of first points and a number of the plurality of second points.

### CROSS-REFERENCE TO RELATED PATENT APPLICATION

The present application claims priority under 35 U.S.C. § 119 (a) to Korean patent application number 10-2024-0051933 filed on Apr. 18, 2024 in the Korean Intellectual Property Office, the entire disclosure of which is incorporated by reference herein.

### BACKGROUND OF THE INVENTION

### 1. Field

The present disclosure relates to a quality test method and a quality test system, and more particularly to a quality test method and a quality test system for testing welding quality.

### 2. Description of the Related Art

A battery cell may include a case which protects an electrode assembly and receives an electrolyte solution or an electrolyte. The case may include a can and a cap. The can and the cap may be joined together by welding.

When external impacts are applied to the case, there is a risk that a material which may be generated in the battery cell may be leaked to the outside because a welding area is easily damaged or loses sealing properties due to a relatively low resistance to the external impacts. In addition, the welding area may be susceptible to damage caused by repeated loads due to vibrations or charging and discharging. Therefore, a quality test is required to ensure that the welding area is formed normally without defects.

### SUMMARY OF THE INVENTION

An aspect of the present disclosure provides a quality test method with improved accuracy. Another aspect of the present disclosure provides a quality test method with improved defect detection capability.

Another aspect of the present disclosure provides a quality test method with improved efficiency.

Another aspect of the present disclosure provides a quality test system with improved accuracy.

Another aspect of the present disclosure provides a quality test system with improved defect detection capability.

Another aspect of the present disclosure provides a quality test system with improved efficiency.

The present disclosure can be widely applied in the fields of electric vehicles, battery charging stations, and other green technologies such as photovoltaics and wind power using batteries. In addition, the present disclosure may be used in eco-friendly mobility, including electric vehicles and hybrid vehicles.

A quality test method of a battery cell including a can having an open surface; a cap welded to the can and covering the open surface; and a welding area formed by welding according to embodiments of the present disclosure may include capturing an image of the welding area with an imaging device, calculating a plurality of first points arranged along a first boundary line and a plurality of second points corresponding to the plurality of first points and arranged along a second boundary line, the first and second boundary lines separating the welding area from a non-welding area in the image, and determining whether the welding area is defective based on a number of the plurality of first points and a number of the plurality of second points.

The determining whether the welding area is defective based on the number of the plurality of first points and the number of the plurality of second points may include determining that the welding area is defective when at least one of the number of the plurality of first points and the number of the plurality of second points is out of a preset reference number range.

The quality test method may further include, when each of the number of the plurality of first points and the number of the plurality of second points is included in the preset reference number range, determining that the welding area is defective when an average value of distances between the plurality of first points and the plurality of second points is out of a preset reference width range.

The quality test method may further include, when each of the number of the plurality of first points and the number of the plurality of second points is included in the preset reference number range, determining that the welding area is of good quality when an average value of distances between the plurality of first points and the plurality of second points is within a preset reference width range.

The quality test method may further include, when each of the number of the plurality of first points and the number of the plurality of second points is included in the preset reference number range, determining that the welding area is defective when a maximum distance among distances between the plurality of first points and the plurality of second points is greater than a maximum value of a preset reference width range.

The quality test method may further include, when each of the number of the plurality of first points and the number of the plurality of second points is included in the preset reference number range, determining that the welding area is defective when a minimum distance among distances between the plurality of first points and the plurality of second points is less than a minimum value of a preset reference width range.

The quality test method may further include setting a region of interest including the welding area in the image, in which the plurality of first points and the plurality of second points are calculated in the region of interest.

A location and a size of the region of interest may be set based on information input by a user.

The calculating the plurality of first points and the plurality of second points may include calculating a point at which a change amount of a color value of each pixel of the image with respect to a predetermined direction exceeds a preset value.

The predetermined direction may cross a direction in which the first boundary line extends and a direction in which the second boundary line extends.

A quality test system according to embodiments of the present disclosure may include a memory in which a quality test program is stored, and a processor controlling the memory, wherein the processor executes the quality test program to: calculate a plurality of first points arranged along a first boundary line and a plurality of second points corresponding to the plurality of first points and arranged along a second boundary line, the first and second boundary lines separating a welding area from a non-welding area in an image obtained by capturing a battery cell including a can having an open surface, a cap welded to the can and covering the open surface, and the welding area formed by welding, and determine whether the welding area is defective based on a number of the plurality of first points and a number of the plurality of second points.

The processor may determine that the welding area is defective when at least one of the number of the plurality of first points and the number of the plurality of second points is out of a preset reference number range.

The processor may determine, when each of the number of the plurality of first points and the number of the plurality of second points is included in a preset reference number range, that the welding area is defective when an average value of distances between the plurality of first points and the plurality of second points is out of a preset reference width range.

The processor may determine, when each of the number of the plurality of first points and the number of the plurality of second points is included in a preset reference number range, that the welding area is of good quality when an average value of distances between the plurality of first points and the plurality of second points is within a preset reference width range.

Spacing between the plurality of first points and spacing between the plurality of second points may be constant.

Spacing between the plurality of first points and spacing between the plurality of second points may be set based on information input by a user.

A quality test method according to embodiments of the present disclosure may include generating an image by capturing a test object including a welding area, calculating a plurality of first points arranged along a first boundary line and a plurality of second points corresponding to the plurality of first points and arranged along a second boundary line, the first and second boundary lines separating a welding area and a non-welding area in the image, and determining whether the welding area is defective when at least one of a number of the plurality of first points and a number of the plurality of second points is out of a preset reference number range.

### BRIEF DESCRIPTION OF THE DRAWINGS

FIG. 1 is a diagram illustrating a battery cell for describing a welding area according to an embodiment of the present disclosure.

FIG. 2 is a diagram for describing a quality test method according to an embodiment of the present disclosure.

FIG. 3 is a flowchart illustrating a quality test method according to an embodiment of the present disclosure.

FIG. 4 is a flowchart illustrating a welding width test method according to an embodiment of the present disclosure.

FIG. 5 is a flowchart illustrating a welding width test method according to another embodiment of the present disclosure.

FIG. 6 is a diagram for describing a quality test method according to an embodiment of the present disclosure.

FIG. 7 is a diagram for describing a quality test method according to an embodiment of the present disclosure.

FIG. 8 is a diagram for describing a quality test method according to an embodiment of the present disclosure.

FIG. 9 is a diagram for describing a quality test method according to an embodiment of the present disclosure.

FIG. 10 is a diagram for describing a quality test method according to an embodiment of the present disclosure.

FIG. 11 is a diagram for describing a quality test system according to an embodiment of the present disclosure.

### DETAILED DESCRIPTION

Structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

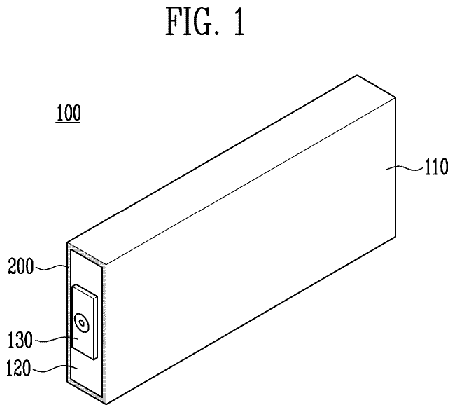

FIG. 1 is a diagram illustrating a battery cell 100 for describing a welding area according to an embodiment of the present disclosure.

Referring to FIG. 1, the battery cell 100 may include a can 110 and a cap 120.

The can 110 may define an interior space for receiving an electrode assembly and an electrolyte solution therein. The can 110 may have a cuboidal shape with one open surface. The can 110 may include an opening which is opened to the one surface. For example, the can 110 may include a metallic material such as aluminum.

The electrode assembly may be arranged in the interior space of the can 110. The electrode assembly includes a first electrode plate, a second electrode plate, and a separator formed in a shape of a thin plate or a film, and may be formed in various forms as necessary, such as a stacked type or a wound type. As an example, the first electrode plate may serve as a cathode, and the second electrode plate may serve as an anode.

The cap 120 may be coupled with the can 110. The cap 120 may close the opening of the can 110. A terminal portion 130 may be arranged on the cap 120. The terminal portion 130 may protrude from the cap 120. The terminal portion 130 may be electrically connected to the electrode assembly accommodated in the can 110.

The can 110 and the cap 120 may be welded together. For example, a welding area 200 may be arranged between the can 110 and the cap 120. The welding area 200 may include weld beads. The welding area 200 may protrude from a surface of can 110 and cap 120. The welding area 200 may be arranged at a boundary where the can 110 and the cap 120 engage. For example, when the cap 120 is inserted and welded to the can 110, the welding area 200 may be arranged along a boundary where an outer surface of the cap 120 and an inner surface of the can 110 meet.

Although FIG. 1 illustrates that the welding area 200 is arranged along a perimeter of the cap 120 at a constant thickness, the embodiment is not limited thereto. The shape of the welding area 200 may be variously modified according to the thickness, material, type of welding material, welding length, welding speed, and the like of the can 110 and the cap 120.

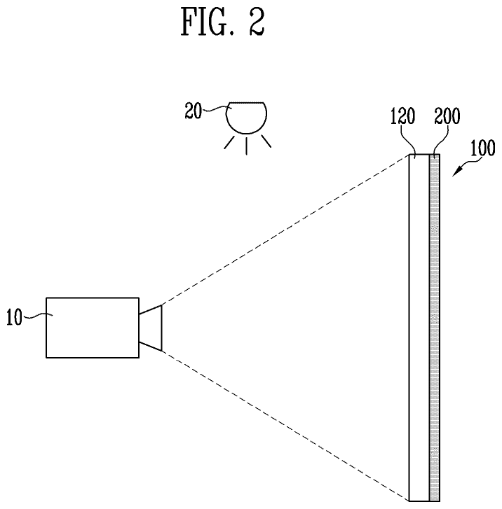

FIG. 2 is a diagram for describing a quality test method according to an embodiment of the present disclosure. For reference, FIG. 2 shows the welding area 200 arranged around the cap 120.

In order to test the welding area 200, an image of the welding area 200 may be captured by an imaging device 10. A lighting 20 may be used when an image of the welding area 200 is captured by the imaging device 10. By observing the shape of the welding area 200, whether the welding area 200 is formed normally or is defective may be tested. The imaging device 10 may include, for example, a vision camera. However, the embodiment is not limited thereto, and the imaging device 10 may be changed according to embodiments. It is possible to determine whether the shape of the welding area 200 is defective by using an image obtained by capturing the welding area 200.

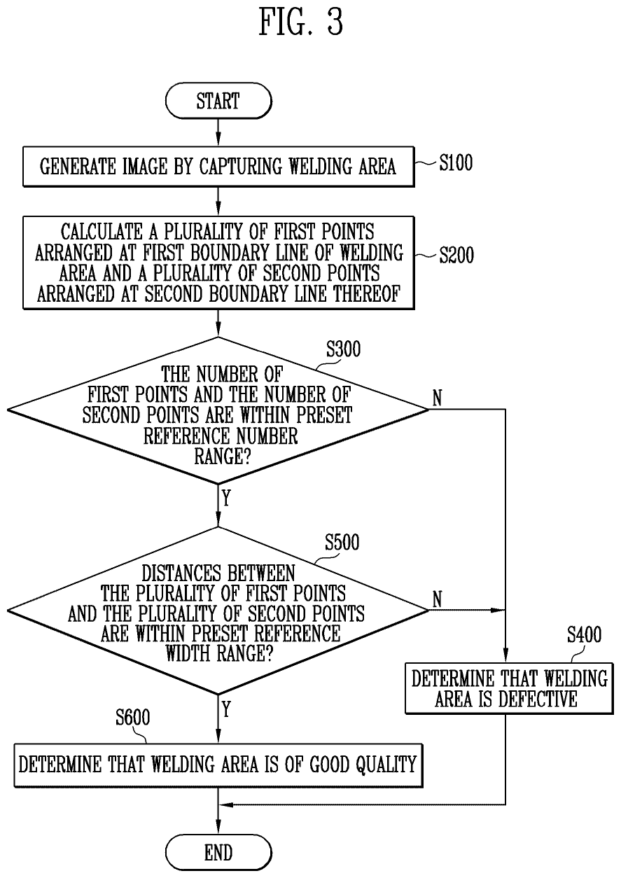

FIG. 3 is a flowchart illustrating a quality test method according to an embodiment of the present disclosure.

Referring to FIG. 3, the quality test method according to the embodiment of the present disclosure may include generating an image by capturing a welding area at step S100.

For example, an image of a battery cell including a welding area may be captured using the imaging device 10 as shown in FIG. 2 and the lighting 20 as shown in FIG. 2.

Subsequently, the quality test method according to the embodiment of the present disclosure may include calculating a plurality of first points arranged at a first boundary line of the welding area and a plurality of second points arranged at a second boundary line of the welding area in an image at step S200. The quality test method according to the embodiment of the present disclosure may include setting a region of interest including the welding area in the image, and the plurality of first points and the plurality of second points may be calculated in the region of interest.

The first boundary line and the second boundary line of the welding area may refer to a boundary line which divides the welding area and a non-welding area. For example, the first boundary line may include a boundary line between the welding area 200 of FIG. 2 and the cap 120 of FIG. 2 in the image obtained by capturing the welding area 200. For another example, the second boundary line may include a boundary line between the welding area 200 in FIG. 2 and an outer region of the battery cell 100 in FIG. 2 in the image obtained by capturing the welding area 200.

Subsequently, the quality test method according to the embodiment of the present disclosure may include determining whether the number of first points and the number of second points are within a preset reference number range at step S300.

Whether there is a defect in the welding area may be determined based on the number of first points and the number of second points. For example, it may be determined whether the number of first points is within the preset reference number range, and it may be determined whether the number of second points is within the predetermined reference number range.

Subsequently, the quality test method according to the embodiment of the present disclosure may include, when the number of first points or the number of second points is not included in the preset reference number range, determining that the welding area is defective at step S400.

For example, even when the number of second points is included in the range of the preset reference number, if the number of first points is greater than a maximum value of the preset reference number, the welding area may be determined to be defective. For another example, even when the number of second points is included in the range of the preset reference number, when the number of first points is less than a minimum value of the preset reference number, the welding area may be determined to be defective.

For another example, even when the number of first points is included in the range of the preset reference number, the welding area may be determined to be defective if the number of second points is greater than the maximum value of the preset reference number. For another example, even when the number of first points is included in the range of the preset reference number, the welding area may be determined to be defective when the number of second points is less than the minimum value of the preset reference number.

Subsequently to step S300, the quality test method according to the embodiment of the present disclosure may include, when the number of first points and the number of second points are within the preset reference number range, determining whether distances between the plurality of first points and the plurality of second points are within a preset reference width range at step S500.

For example, it may be determined whether an average value of the distances between the plurality of first points and the plurality of second points is within the preset reference width range. For another example, it may be determined whether a maximum distance among the distances between the plurality of first points and the plurality of second points is greater than a maximum value of the preset reference width range. For another example, it may be determined whether a minimum distance among the distances between the plurality of first points and the plurality of second points is less than a minimum value of the preset reference width range.

Subsequently, the quality test method according to the embodiment of the present disclosure may include, when the distances between the plurality of first points and the plurality of second points are within the preset reference width range, determining the welding area to be of good quality at step S600.

For example, when the average value of the distances between the plurality of first points and the plurality of second points is within the preset reference width range, the welding area may be determined to be of good quality. When the average value of the distances between the plurality of first points and the plurality of second points is greater than or equal to the minimum value of the preset reference width range and less than or equal to the maximum value thereof, the welding area may be determined to be of good quality.

For another example, when the maximum distance among the distances between the plurality of first points and the plurality of second points is greater than or equal to the minimum value of the preset reference width range and less than or equal to the maximum value thereof, the welding area may be determined to be of good quality.

For another example, when the minimum distance among the distances between the plurality of first points and the plurality of second points is greater than or equal to the minimum value of the preset reference width range and less than or equal to the maximum value thereof, the welding area may be determined to be of good quality.

Following step S500, the quality test method according to the embodiment of the present disclosure may include determining that the welding area is defective when the distances between the plurality of first points and the plurality of second points are not included in the preset reference width range at step S400.

For example, when the average value of the distances between the plurality of first points and the plurality of second points is not included in the preset reference width range, the welding area may be determined to be defective. When the average value of the distances between the plurality of first points and the plurality of second points is less than the minimum value of the preset reference width range or greater than the maximum value thereof, the welding area may be determined to be defective.

For another example, when the maximum distance among the distances between the plurality of first points and the plurality of second points is greater than the maximum value of the preset reference width range, the welding area may be determined to be defective.

For another example, when the minimum distance among the distances between the plurality of first points and the plurality of second points is less than the minimum value of the preset reference width range, the welding area may be determined to be defective.

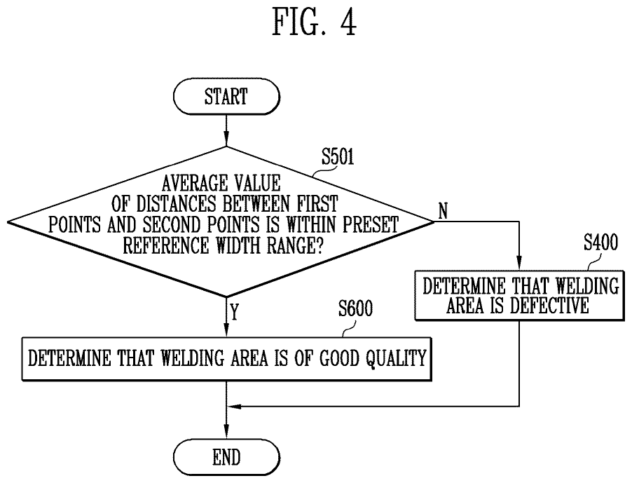

FIG. 4 is a flowchart illustrating a welding width test method according to an embodiment of the present disclosure. For reference, FIG. 4 is a flowchart showing steps following step S300 of FIG. 3.

Referring to FIG. 4, the quality test method according to the embodiment of the present disclosure may include determining whether the average value of the distances between plurality of first points and plurality of second points is within the preset reference width range at step S501.

When the average value of the distances between the plurality of first points and the plurality of second points is within the preset reference width range, the quality test method according to the embodiment of the present disclosure may include determining the welding area to be of good quality at step S600.

When the average value of the distances between the plurality of first points and the plurality of second points is not within the preset reference width range, the quality test method according to the embodiment of the present disclosure may include determining that the welding area is defective at step S400.

Based on the average value of the distances between the plurality of first points and the plurality of second points, the welding quality test may be terminated when it is determined whether the welding area is of good quality or defective. That is, it is possible to determine whether the welding area is of good quality or defective by determining only whether the average value of the distances between the plurality of first points and the plurality of second points is included in the preset reference width range, without individually determining the respective distances between the plurality of first points, and the plurality of second points.

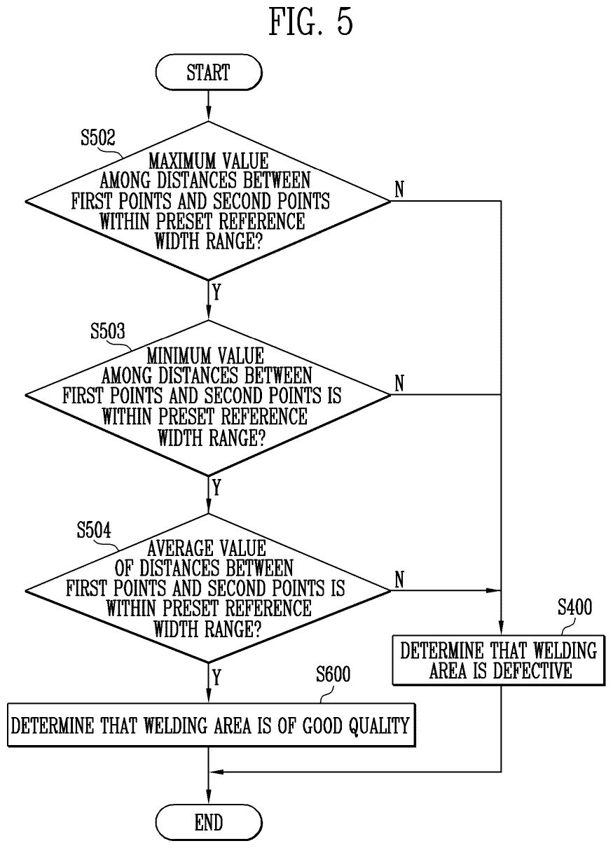

FIG. 5 is a flowchart illustrating a welding width test method according to another embodiment of the present disclosure. For reference, FIG. 5 is a flowchart showing steps following step S300 of FIG. 3.

Referring to FIG. 5, a quality test method according to the embodiment of the present disclosure may include determining whether the maximum distance among the distances between the plurality of first points and the plurality of second points is within the preset reference width range at step S502.

Subsequently, when the maximum distance among the distances between the plurality of first points and the plurality of second points is not within the preset reference width range, the quality test method according to the embodiment of the present disclosure may include determining that the welding area is defective at step S400.

For example, when the maximum distance among the distances between the plurality of first points and the plurality of second points is greater than the maximum value of the preset reference width range, the welding area may be determined to be defective. For another example, when the maximum distance among the distances between the plurality of first points and the plurality of second points is less than the minimum value of the preset reference width range, the welding area may be determined to be defective.

Subsequently to step S502, when the maximum distance among the distances between the plurality of first points and the plurality of second points is within the preset reference width range, the quality test method according to the embodiment of the present disclosure may include determining whether the minimum distance among the distances between the plurality of the first points and the plurality of second points is within the preset reference width range at step S503.

Subsequently, when the minimum distance among the distances between the plurality of first points and the plurality of second points is not within the preset reference width range, the quality test method according to the embodiment of the present disclosure may include determining that the welding area is defective at step S400.

For example, when the minimum distance among the distances between the plurality of first points and the plurality of second points is less than the minimum value of the preset reference width range, the welding area may be determined to be defective.

Subsequently to step S503, when the minimum distance among the distances between the plurality of first points and the plurality of second points is within the preset reference width range, the quality test method according to the embodiment of the present disclosure may include determining whether the average value of the distances between the plurality of first point and the second points is within the preset reference width range at step S504.

Subsequently, when the average value of the distances between the plurality of first points and the plurality of second points is within the preset reference width range, the quality test method according to the embodiment of the present disclosure may include determining the welding area to be of good quality at step S600.

For example, when the average value of the distances between the plurality of first points and the plurality of second points is greater than or equal to the minimum value and less than or equal to the maximum value of the preset reference width range, the welding area may be determined to be of good quality.

When the average value of the distances between the plurality of first points and the plurality of second points is not within the preset reference width range, the quality test method according to the embodiment of the present disclosure may include, following step S504, determining that the welding area is defective at step S400.

For example, when the average value of the distances between the plurality of first points and the plurality of second points is less than the minimum value of the preset reference width range or greater than the maximum value thereof, the welding area may be determined to be defective.

Based on the average value, the maximum distance, and the minimum distance among the distances between the plurality of first points and the plurality of second points, the welding quality test may be terminated when it is determined whether the welding area is of good quality or defective.

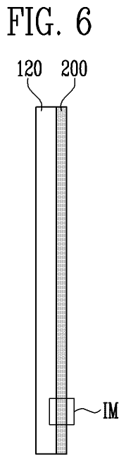

FIG. 6 is a diagram for describing a quality test method according to an embodiment of the present disclosure.

Referring to FIG. 6, the quality test method according to the embodiment of the present disclosure may include capturing the welding area 200 to obtain an image IM. The image IM may include not only the welding area 200, but also a non-welding area. For example, the image IM may include at least a portion of the cap 120 of the battery cell 100 in FIG. 1. The image IM may include a portion across the cap 120 and the welding area 200.

Although the image IM is shown in FIG. 6 as including only a portion of the welding area 200, the embodiment is not limited thereto. For example, the image IM may include the entire welding area 200 and a region of interest may be set in the image IM. The region of interest may include only a part of the image IM. The size and location of the region of interest may be set based on data input by a user.

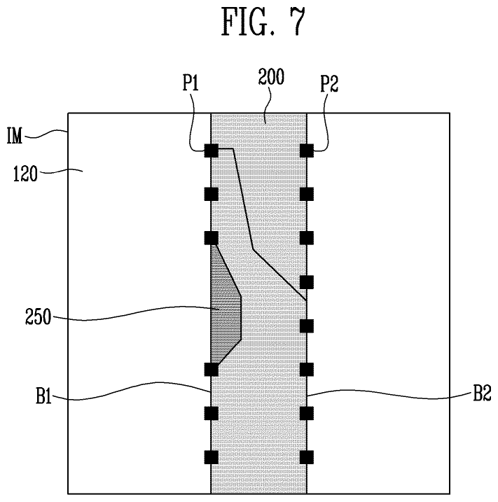

FIG. 7 is a diagram for describing a quality test method according to an embodiment of the present disclosure.

Referring to FIG. 7, a plurality of first points P1 and a plurality of second points P2 may be calculated in the image IM. The plurality of first points P1 may be arranged at a first boundary line B1 of the welding area 200. The plurality of second points P2 may be arranged at a second boundary line B2 of the welding area 200. The first boundary line B1 and the second boundary line B2 may distinguish the welding area 200 from the non-welding area. For example, the first boundary line B1 may be a boundary separating the welding area 200 from the cap 120 in the image IM. The second boundary line B2 may be a boundary separating the welding area 200 from the outer region of the battery cell.

The plurality of first points P1 and the plurality of second points P2 may correspond to each other. The first point P1 and the second point P2 corresponding to each other may be arranged next to each other. The spacing between the plurality of first points P1 and the spacing between the plurality of second points P2 may be set based on the information input by the user. The spacing between the plurality of first points P1 and the spacing between the plurality of second points P2 may be constant.

The plurality of first points P1 and the plurality of second points P2 may be calculated based on the data of the image IM. The plurality of first points P1 and the plurality of second points P2 may be calculated based on a color value of each pixel of the image IM. For example, the plurality of first points P1 and the plurality of second points P2 may be calculated based on a gray scale value of each pixel of the image IM. For another example, the plurality of first points P1 and the plurality of second points P2 may be calculated based on an RGB scale value of each pixel of the image IM.

The plurality of first points P1 and the plurality of second points P2 may be calculated at points where the amount of change in the color value of each pixel of the image IM with respect to a predetermined direction is greater than a preset value. The predetermined direction crosses a direction in which the first boundary line B1 extends and a direction in which the second boundary line B2 extends. Specifically, the plurality of first points P1 and the plurality of second points P2 may be calculated for points at which the amount of change in the color value of each pixel of the image IM with respect to the intersecting direction of the welding area 200 and the extending direction of the welding area 200 exceeds the preset value. For example, when the welding area 200 extends in a first direction, the amount of change in the color value of each pixel of the image IM with respect to a direction perpendicular to the first direction may be calculated. The change amount of the color value of the pixel of the image IM at the first boundary line B1 may be greater than the preset value. Thus, the plurality of first points P1 may be calculated at the first boundary line B1. In addition, the amount of change in the color value of each pixel of the image IM at the second boundary line B2 may be greater than the preset value. Thus, the plurality of second points P2 may be calculated at the second boundary line B2.

In the process of forming the welding area 200, a defective portion 250 may be formed. The defective portion 250 may be included in the image IM. For example, the defective portion 250 may be an interior region of the can 110 in FIG. 1 which is closed with the cap 120. For another example, the defective portion 250 may be formed when the welding area 200 is crushed.

When the defective portion 250 is present, at least some of the plurality of first points P1 or the plurality of second points P2 may not be calculated. For example, some of the first points P1 may not be calculated at the first boundary line B1 where the defective portion 250 is located. As a result, the number of first points P1 may not be included in the preset reference number range. For example, the number of first points P1 may be less than the minimum value of the preset reference number. Accordingly, the welding area 200 may be determined to be defective.

Even when some of the first points P1 are not calculated at the first boundary line B1 where the defective portion 250 is located, if the number of first points P1 is included in the preset reference number range, the welding area 200 may be determined to be of good quality.

Although FIG. 7 shows that some of the first points P1 are not calculated, the embodiment is not limited thereto. For example, some of the second points P2 may not be calculated, or some of the first points P1 and some of the second points P2 may not be calculated.

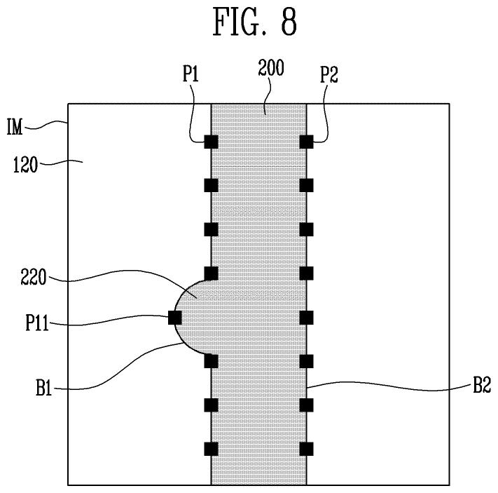

FIG. 8 is a diagram for describing a quality test method according to an embodiment of the present disclosure. For convenience of explanation, differences from those described with reference to FIG. 7 will be mainly explained.

Referring to FIG. 8, a protrusion 220 may be formed in the process of forming the welding area 200. The welding area 200 may include the protrusion 220. The protrusion 220 may be a portion where the welding area 200 further protrudes to an area outside the weld. The first boundary line B1 may include a boundary between the protrusion 220 and the cap 120. A protruding point P11 may be calculated at the first boundary line B1 where the protrusion 220 is arranged. The protruding point P11 may include, for example, a point arranged on the first boundary line B1 of the protrusion 220 among the plurality of first points P1. Although FIG. 8 shows that there is only one protruding point P11, the embodiment is not limited thereto. For example, there may be a plurality of protruding points.

When the number of first points P1 and the number of second points P2 are included in the preset reference number range, whether the welding area 200 is defective may be determined based on the distances between the plurality of first points P1 and the plurality of second points P2.

For example, when the average value of distances between the plurality of first points P1 and the plurality of second points P2 is included in the preset reference width range, the welding area 200 may be determined to be of good quality.

For another example, the distance between the protruding point P11 and the corresponding second point P2 may be the maximum distance among the distances between the plurality of first points P1 and the plurality of second points P2. When the distance between the protruding point P11 and the corresponding second point P2 is greater than the maximum value of the preset reference width range, the welding area 200 may be determined to be defective.

For another example, when the distance between the protruding point P11 and the corresponding second point P2 is the maximum distance among the distances between the plurality of first points P1 and the plurality of second points P2, and the distance between the protruded point P11 and the corresponding second point P2 is less than the maximum value of the preset reference width range and greater than the minimum value thereof, the welding area 200 may be determined to be of good quality.

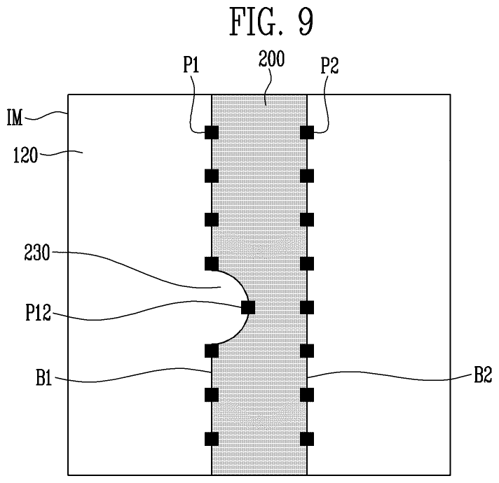

FIG. 9 is a diagram for describing a quality test method according to an embodiment of the present disclosure. For convenience of explanation, differences from those described with reference to FIGS. 7 and 8 will be mainly explained.

Referring to FIG. 9, a recess 230 may be formed when the welding area 200 is formed. The welding area 200 may include the recess 230. The recess 230 may be a portion into which the welding area 200 is recessed. The first boundary line B1 may include a boundary between the recess 230 and the cap 120. A recess point P12 may be calculated at the first boundary line B1 where the recess 230 is arranged. The recess point P12 may include, for example, a point arranged at the first boundary line B1 of the recess 230 among the plurality of first points P1. Although FIG. 9 shows that there is only one recess point P12, the embodiment is not limited thereto. For example, there may be a plurality of recess points.

When the number of first points P1 and the number of second points P2 are included in the preset reference number range, whether the welding area 200 is defective may be determined based on the distances between the plurality of first points P1 and the plurality of second points P2.

For example, when the average value of the distances between the plurality of first points P1 and the plurality of second points P2 is included in the preset reference width range, the welding area 200 may be determined to be of good quality.

For another example, the distance between the recess point P12 and the corresponding second point P2 may be the minimum distance among the distances between the plurality of first points P1 and the plurality of second points P2. When the distance between the recess point P12 and the corresponding second point P2 is smaller than the minimum value of the preset reference width range, the welding area 200 may be determined to be defective.

For another example, the welding area 200 may be determined to be of good quality when the distance between the recess point P12 and the corresponding second point P2 is the maximum distance among the distances between the plurality of first points P1 and the plurality of second points P2, and the distance between the recess point P12 and the corresponding second point P2 is greater than the minimum value and less than the maximum value of the preset reference width range.

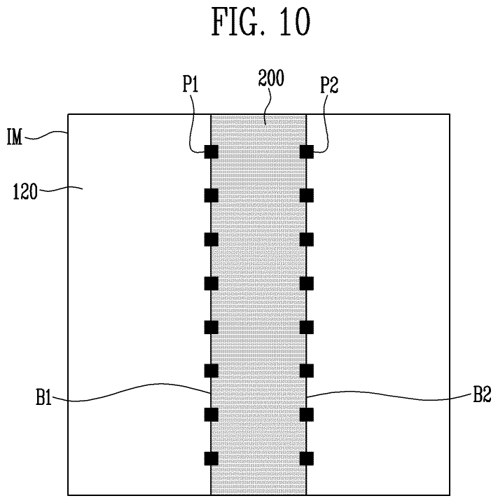

FIG. 10 is a diagram for describing a quality test method according to an embodiment of the present disclosure. For convenience of explanation, differences from those described with reference to FIGS. 7 to 9 will be mainly described.

Referring to FIG. 10, when the number of first points P1 and the number of second points P2 are included in the preset reference number range, whether the welding area 200 is defective may be determined based on the distances between the plurality of first points P1 and the plurality of second points P2.

For example, when the average value of the distances between the plurality of first points P1 and the plurality of second points P2 is included in the preset reference width range, the welding area 200 may be determined to be of good quality. Conversely, when the average value of the distances between the plurality of first points P1 and the plurality of second points P2 is not included in the preset reference width range, the welding area 200 may be determined to be defective.

As another example, the welding area 200 may be determined to be of good quality when the maximum distance among the distances between the plurality of first points P1 and the plurality of second points P2 of the preset reference width range is less than the maximum value and greater than the minimum value thereof. Conversely, when the maximum distance among the distances between the plurality of first points P1 and the plurality of second points P2 is greater than the maximum value of the preset reference width range, the welding area 200 may be determined to be defective.

As another example, the welding area 200 may be determined to be of good quality when the minimum distance among the distances between the plurality of first points P1 and the plurality of second points P2 is greater than the minimum value and less than the maximum value of the preset reference width range. Conversely, when the minimum distance among the distances between the plurality of first points P1 and the plurality of second points P2 is less than the minimum value of the preset reference width range, the welding area 200 may be determined to be defective.

Although FIG. 10 shows that the plurality of first points P1 and the plurality of second points P2 are all paired at regular intervals, the embodiment is not limited thereto. For example, some of the first points P1 may not be calculated at the first boundary line B1. However, the number of first points P1 may be included in the preset reference number range. Thus, the welding area 200 may be determined to be of good quality. That is, even when some of the first points P1 are not calculated because the amount of change in the color value of the pixel of the image IM does not exceed the preset value at the first boundary line B1, the welding area 200 may be determined to be of good quality if the number of first points P1 is included in the preset reference number range and the number of second points P2 is included in the predetermined reference number range.

In FIG. 10, the width of the welding area 200 is shown to be constant, but the embodiment is not limited thereto. For example, the width of the welding area 200 may vary across the plurality of first points P1 and the plurality of second points P2.

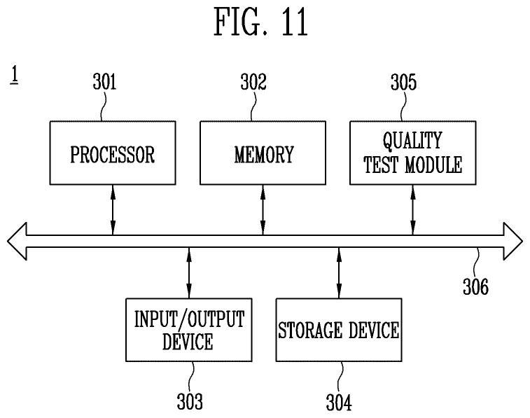

FIG. 11 is a diagram for describing a quality test system 1 according to an embodiment of the present disclosure.

Referring to FIG. 11, the quality test system 1 according to an embodiment of the present disclosure may include a processor 301, a memory 302, an input/output device 303, a storage device 304, and a quality test module 305.

The quality test system 1 may, for example, be an integrated device. For example, the quality test system 1 may be provided as a dedicated device for testing welding quality. For another example, the quality test system 1 may be a computer for running various modules for testing welding quality.

The processor 301 may control the quality test system 1. The processor 301 may execute an operating system, firmware, and the like for driving the quality test system 1.

The processor 301 may include a core capable of executing arbitrary instructions, such as a micro-processor, an Application Processor (AP), a Digital Signal Processor (DSP), or a Graphic Processing Unit (GPU).

The processor 301 may communicate with the memory 302, the input/output device 303, and the storage device 304 via a bus 306. The processor 301 may execute the quality test module 305 loaded in the memory 302 to determine whether the welding area is defective.

The processor 301 may calculate a plurality of first points and a plurality of second points in the image including the welding area by using the quality test module 305 loaded in the memory 302. The processor 301 may determine whether the number of first points and the number of second points are included in the preset reference number range by using the quality test module 305 loaded in the memory 302. The processor 301 may determine whether the distances between the plurality of first points and the plurality of second points fall within the preset reference width range by using the quality test module 305 loaded in the memory 302.

The quality test module 305 may be a software module or a program including a plurality of instructions executed by the processor 301. The quality test module 305 may be stored on a computer-readable storage medium. For example, the quality test module 305 may be a quality test program.

The memory 302 may temporarily store the quality test module 305. The quality check module 305 may be loaded into the memory 302 from the storage device 304.

The memory 302 may be a volatile memory such as SRAM, DRAM, etc., or a non-volatile memory such as PRAM, MRAM ReRAM, FRAM NOR flash memory, etc.

The input/output device 303 may control user input and output from user interface devices. For example, the input/output device 303 may include an input device such as a keyboard, a mouse, a touchpad, etc., to receive various types of data. For example, the input/output device 303 may include an output device such as a display, a speaker, or the like, and may display various types of data. By the input/output device 303, the image IM as shown in FIGS. 7 to 10 in which the plurality of first points P1 in FIGS. 7 and 10 and the plurality of second points P2 in FIG. 7 or 10 are displayed may be output to the user. Through the input/output device 303, the processor 301 may receive data necessary for calculating the plurality of first points P1 in FIGS. 7 to 10 and the plurality of second points P2 in FIGS. 7 and 10 from the user.

The storage device 304 may store various types of data related to the quality test module 305. The storage device 304 may store codes such as an operating system or firmware executed by the processor 301.

The storage device 304 may include, for example, a memory card (MMC, eMMC, SD, MicroSD, etc.), a solid state drive (SSD), a hard disk drive (HDD), etc.

According to an embodiment of the present disclosure, the accuracy of a quality test method may be improved.

According to another embodiment of the present disclosure, the defect detection capability of the quality test method may be improved.

According to another embodiment of the present disclosure, the efficiency of the quality test method may be improved.

According to another embodiment of the present disclosure, the accuracy of a quality test system may be improved.

According to another embodiment of the present disclosure, the defect detection capability of the quality test system may be improved.

According to another embodiment of the present disclosure, the efficiency of the quality test system may be improved.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A quality test method of a battery cell including a can having an open surface; a cap welded to the can and covering the open surface; and a welding area formed by welding, the quality test method comprising:
capturing an image of the welding area with an imaging device;
calculating a plurality of first points arranged along a first boundary line and a plurality of second points corresponding to the plurality of first points and arranged along a second boundary line, the first and second boundary lines separating the welding area from a non-welding area in the image; and
determining whether the welding area is defective based on a number of the plurality of first points and a number of the plurality of second points.

2. The quality test method according to claim 1, wherein the determining whether the welding area is defective based on the number of the plurality of first points and the number of the plurality of second points comprises determining that the welding area is defective when at least one of the number of the plurality of first points and the number of the plurality of second points is out of a preset reference number range.

3. The quality test method according to claim 2, further comprising, when each of the number of the plurality of first points and the number of the plurality of second points is included in the preset reference number range, determining that the welding area is defective when an average value of distances between the plurality of first points and the plurality of second points is out of a preset reference width range.

4. The quality test method according to claim 2, further comprising, when each of the number of the plurality of first points and the number of the plurality of second points is included in the preset reference number range, determining that the welding area is of good quality when an average value of distances between the plurality of first points and the plurality of second points is within a preset reference width range.

5. The quality test method according to claim 2, further comprising, when each of the number of the plurality of first points and the number of the plurality of second points is included in the preset reference number range, determining that the welding area is defective when a maximum distance among distances between the plurality of first points and the plurality of second points is greater than a maximum value of a preset reference width range.

6. The quality test method according to claim 2, further comprising, when each of the number of the plurality of first points and the number of the plurality of second points is included in the preset reference number range, determining that the welding area is defective when a minimum distance among distances between the plurality of first points and the plurality of second points is less than a minimum value of a preset reference width range.

7. The quality test method according to claim 1, further comprising setting a region of interest including the welding area in the image,
wherein the plurality of first points and the plurality of second points are calculated in the region of interest.

8. The quality test method according to claim 7, wherein a location and a size of the region of interest are set based on information input by a user.

9. The quality test method according to claim 1, wherein the calculating the plurality of first points and the plurality of second points comprises calculating a point at which a change amount of a color value of each pixel of the image with respect to a predetermined direction exceeds a preset value.

10. The quality test method according to claim 9, wherein the predetermined direction crosses a direction in which the first boundary line extends and a direction in which the second boundary line extends.

11. A quality test system, comprising:
a memory in which a quality test program is stored; and
a processor controlling the memory,
wherein the processor executes the quality test program to:
calculate a plurality of first points arranged along a first boundary line and a plurality of second points corresponding to the plurality of first points and arranged along a second boundary line, the first and second boundary lines separating a welding area from a non-welding area in an image obtained by capturing a battery cell including a can having an open surface, a cap welded to the can and covering the open surface, and the welding area formed by welding, and
determine whether the welding area is defective based on a number of the plurality of first points and a number of the plurality of second points.

12. The quality test system according to claim 11, wherein the processor determines that the welding area is defective when at least one of the number of the plurality of first points and the number of the plurality of second points is out of a preset reference number range.

13. The quality test system according to claim 11, wherein the processor determines, when each of the number of the plurality of first points and the number of the plurality of second points is included in a preset reference number range, that the welding area is defective when an average value of distances between the plurality of first points and the plurality of second points is out of a preset reference width range.

14. The quality test system according to claim 11, wherein the processor determines, when each of the number of the plurality of first points and the number of the plurality of second points is included in a preset reference number range, that the welding area is of good quality when an average value of distances between the plurality of first points and the plurality of second points is within a preset reference width range.

15. The quality test system according to claim 11, wherein spacing between the plurality of first points and spacing between the plurality of second points are constant.

16. The quality test system according to claim 11, wherein spacing between the plurality of first points and spacing between the plurality of second points are set based on information input by a user.

17. A quality test method comprising:
generating an image by capturing a test object including a welding area;
calculating a plurality of first points arranged along a first boundary line and a plurality of second points corresponding to the plurality of first points and arranged along a second boundary line, the first and second boundary lines separating a welding area and a non-welding area in the image; and
determining whether the welding area is defective when at least one of a number of the plurality of first points and a number of the plurality of second points is out of a preset reference number range.
